(19) United States
(12) Patent Application Publication
(10) Pub. No.: US 2025/0166612 A1
(43) Pub. Date: May 22, 2025

(54) AUDIO GENERATION METHOD AND SYSTEM, DEVICE, AND STORAGE MEDIUM

(71) Applicant: Beijing Zitiao Network Technology Co., Ltd., Beijing (CN)

(72) Inventors: Hongxu Xu, Beijing (CN); Bing Yang, Beijing (CN)

(21) Appl. No.: 18/948,965

(22) Filed: Nov. 15, 2024

(30) Foreign Application Priority Data
Nov. 17, 2023 (CN) 202311541040.2

(51) Int. Cl. G10L 13/10

(52) U.S. Cl. CPC G10L 13/10; G10L 2013/105

(57) ABSTRACT

The audio generation method includes: receiving first streaming text, and converting the first streaming text into first audio; receiving second streaming text located after the first streaming text, and determining a target time point during receiving of the second streaming text based on a number of characters of the received second streaming text or interval duration between receiving of adjacent characters; obtaining audio duration of the first audio after the target time point as unplayed duration of the first audio; and converting, starting from the target time point, the second streaming text into second audio within a duration range defined by the unplayed duration and playing interval duration, where the playing interval duration represents a maximum time interval between an end time point of the first audio and a start time point of the second audio.

### CROSS-REFERENCE TO RELATED APPLICATION(S)

This application claims priority to Chinese Application No. 202311541040.2 filed Nov. 17, 2023, the disclosure of which is incorporated herein by reference in its entirety.

### FIELD

The present disclosure relates to the field of audio processing technologies, and in particular, to an audio generation method and system, a device, and a storage medium.

### BACKGROUND

Currently, in some application scenarios, text output by a language model needs to be converted into audio for playing. Because the language model outputs text character by character or word by word, usually, the text needs to be accumulated before audio conversion of the text output by the language model. When a number of pieces of accumulated text meets requirements, the accumulated text may be segmented and a sentence obtained through segmentation may be converted into audio.

### SUMMARY

In view of this, implementations of the present disclosure provide an audio generation method, an audio generation system, an electronic device, and a computer-readable storage medium.

One aspect of the present disclosure provides an audio generation method. The method includes:
receiving first streaming text, and converting the first streaming text into first audio;
receiving second streaming text located after the first streaming text, and determining a target time point during receiving of the second streaming text based on a number of characters of the received second streaming text or interval duration between receiving of adjacent characters;
obtaining audio duration of the first audio after the target time point as unplayed duration of the first audio; and
converting, starting from the target time point, the second streaming text into second audio within a duration range defined by the unplayed duration and playing interval duration, where the playing interval duration represents a maximum time interval between an end time point of the first audio and a start time point of the second audio.

In another aspect, the present disclosure further provides a non-transitory computer-readable storage medium, where the non-transitory computer-readable storage medium is configured to store a computer program, and when the computer program is executed by a processor, the method described above is implemented.

In another aspect, the present disclosure further provides an electronic device, where the electronic device includes a processor and a memory, the memory is configured to store a computer program, and when the computer program is executed by the processor, the method described above is implemented.

In technical solutions of some embodiments of the present application, after the received first streaming text is converted into the first audio, during receiving of the second streaming text, the unplayed duration of the first audio after the target time point is obtained, and the second streaming text is converted into the second audio within a duration range defined by the unplayed duration and the playing interval duration.

### BRIEF DESCRIPTION OF THE DRAWINGS

The features and advantages of the present disclosure will be understood more clearly with reference to the accompanying drawings, and the accompanying drawings are schematic and should not be construed as any limitation on the present disclosure. In the accompanying drawings:

FIG. 1 is a schematic diagram of an audio conversion system according to an embodiment of the present application;

FIG. 2 is a schematic flowchart of an audio generation method according to an embodiment of the present application;

FIG. 3 is a schematic sequence diagram of an audio generation method according to an embodiment of the present application;

FIG. 4 is a schematic sequence diagram of an audio generation method according to another embodiment of the present application;

FIG. 5 is a schematic sequence diagram of an audio generation method according to another embodiment of the present application;

FIG. 6 is a schematic diagram of an electronic device according to an embodiment of the present application.

### DETAILED DESCRIPTION OF EMBODIMENTS

In order to make the objectives, technical solutions, and advantages of implementations of the present disclosure clearer, the technical solutions in the implementations of the present disclosure will be described clearly and completely below with reference to the accompanying drawings in the implementations of the present disclosure. Apparently, the described implementations are some rather than all of the implementations of the present disclosure. All the other implementations obtained by those skilled in the art based on the implementations of the present disclosure without any creative effort shall fall within the scope of protection of the present disclosure.

In some technologies, in one aspect, due to performance of the language model itself, a text generation speed is unstable; and in another aspect, due to network transmission, it may take a long time for the text output by the language model to be transmitted to an audio conversion server, which often leads to a problem of a delay in audio broadcasting, that is, audio of a next sentence has not been broadcast long after audio of a current sentence has been broadcast.

In view of this, there is an urgent need for a method that can solve a problem of an audio playing delay.

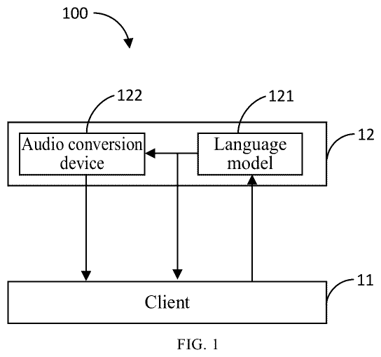

FIG. 1 is a schematic diagram of an audio conversion system 100 according to an embodiment of the present application. In FIG. 1, the audio conversion system 100 includes a client 11 and a server 12. The client 11 is communicatively connected to the server 12. The server 12 may be deployed with a language model 121 and an audio conversion device 122. The language model 121 may be configured to implement text translation, question answering, text classification, and other functions. A workflow of the audio conversion system 100 may be as follows:

1) The client 11 receives target content to be processed by the language model 121 and sends the target content to the language model 121. For example, when the language model 121 is configured to implement the text translation function, the target content may be text to be translated. When the language model 121 is configured to implement the question answering function, the target content may be a question that needs to be answered by the language model 121.

2) The language model 121 processes the target content and sends a processing result to the audio conversion device 122 and the client 11. For example, when the language model 121 is configured to implement the text translation function, the processing result may include a result obtained by translating the target content. When the language model 121 is configured to implement the question answering function, the processing result may include a result of answering the target content.

The processing result may specifically be streaming text. The streaming text means characters serially output by the language model 121 in chronological order. To put it simply, the language model 121 may serially output the processing result within a specific time range in units of one or more characters. For example, the language model 121 may output “ [symbol] ” in the 1.1^{th} second, “ [symbol] ” in the 2^{nd} second, “ [symbol] ” in the 2.5^{th} second, “ [symbol] ” in the 2.7^{th} second, “ [symbol] ” in the 3^{rd} second, “ [symbol] ” in the 3.1^{th} second, and “ [symbol] ” in the 3.5^{th} second, that is, “ [symbol] [symbol] , [symbol] ” are sequentially output as the processing result.

3) The audio conversion device 122 receives and accumulates the processing result sent by the language model 121, and when the accumulated processing result may be segmented into one or more sentences, the audio conversion device segments the accumulated processing result and converts the sentence obtained through segmentation into audio. For example, after obtaining “ [symbol] , [symbol] (It's a nice day to be out)” through accumulation, the audio conversion device 122 may segment the accumulated processing result at the comma to obtain two sentences of “ [symbol] ” and “ [symbol] ” and convert the two sentences into audio respectively. Alternatively, after obtaining “ [symbol] ” through accumulation, the audio conversion device 122 may segment and convert the sentence “ [symbol] ” into audio.

4) The audio conversion device 122 returns the audio obtained through conversion to the client 11.

5) The client 11 plays the received audio, and displays, in a text form, the processing result returned by the language model 121.

In this way, the client 11 can support viewing of the processing result of the target content in both visual and auditory ways.

In the audio conversion system 100 shown in FIG. 1, in one aspect, due to performance of the language model 121 itself or network transmission, a problem of a playing delay may occur. The delay means that after playing of a current piece of audio is completed, it takes a long time to continue to play a next piece of audio. In this case, the playing of the next piece of audio is subjected to a playing delay. For example, after sending the audio of “ [symbol] ” to the client 11, the audio conversion device 122 then receives “ [symbol] ”, but receives no “ [symbol] ” due to the network or the like. Because “ [symbol] ” cannot form a sentence, the audio conversion device 122 may continue to wait, to accumulate more characters. In this case, after the client 11 completes playing of the audio “ [symbol] ”, the audio conversion device 122 may not obtain the next piece of audio through conversion. As a result, after playing of the audio “ [symbol] ” is completed, it takes a long time to continue to play the next piece of audio, that is, there is a playing delay for the next piece of audio. In another aspect, if a sentence is long, receiving of the sentence may not be completed yet when playing of a current piece of audio is completed. This may also lead to a playing delay of audio of the sentence.

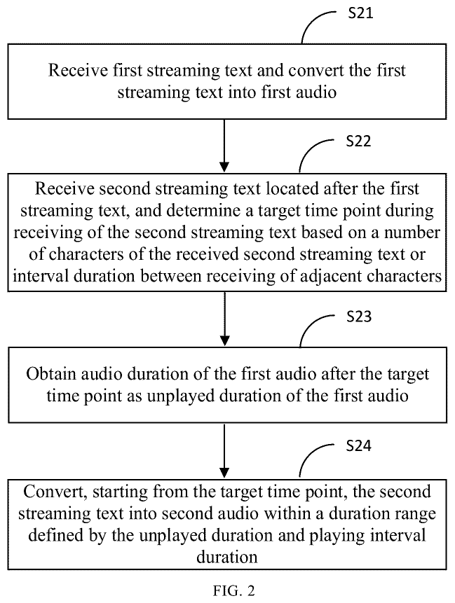

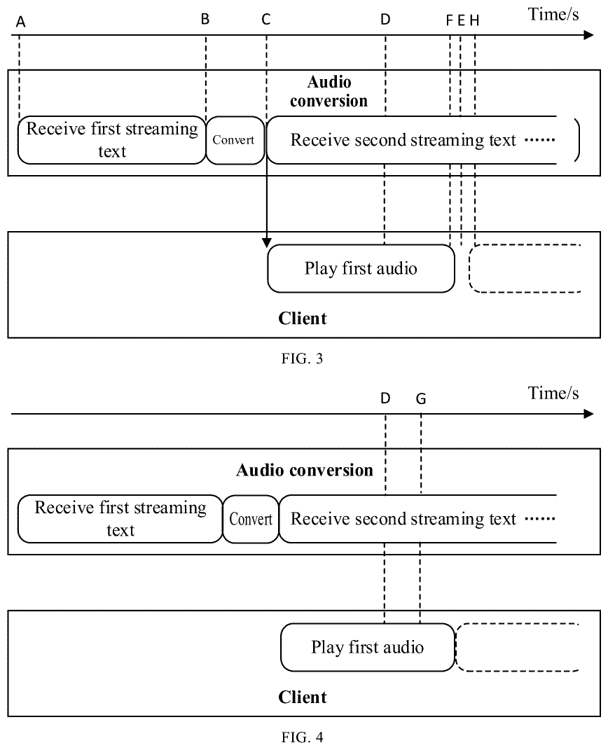

In view of this, the present application provides an audio generation method, to solve the problem of an audio playing delay. The audio generation method may be applied to an audio conversion device. Refer to FIG. 2 and FIG. 3. FIG. 2 is a schematic flowchart of an audio generation method according to an embodiment of the present application. FIG. 3 is a schematic sequence diagram of an audio generation method according to an embodiment of the present application. In FIG. 2, the audio generation method includes the following steps:

Step S21: Receive first streaming text, and convert the first streaming text into first audio.

Referring to FIG. 3, the first streaming text may be streaming text that has been received by the audio conversion device and for which audio conversion has been completed. After the first streaming text is converted into the first audio, the first audio may be sent to a client for playing.

In FIG. 3, the audio conversion device receives the first streaming text within a time period AB, converts the first streaming text into the first audio within a time period BC, and returns, at a time point C, the first audio to the client for playing.

Step S22: Receive second streaming text located after the first streaming text, and determine a target time point during receiving of the second streaming text based on a number of characters of the received second streaming text or interval duration between receiving of adjacent characters.

Referring to FIG. 3, the second streaming text may be streaming text that is being received by the audio conversion device but for which audio conversion has not been completed. During playing of the first audio by the client, the audio conversion device may receive the second streaming text.

The target time point is a time point that occurs during receiving of the second streaming text and may cause a playing delay of audio of the second streaming text. Specifically, with reference to the description related to FIG. 1, it can be learned that, in one aspect, during receiving of the second streaming text, if interval duration between receiving of two adjacent characters is long, the audio conversion device waits a long time when accumulating characters. This may cause a playing delay problem to the audio of the second streaming text. In another aspect, if a sentence in the second streaming text is long, the audio conversion device only receives the second streaming text for a long time, but performs no audio conversion of the second streaming text. This may also cause a playing delay problem to the audio of the second streaming text. The determining of the target time point is described below based on the reasons in the above two aspects.

In some embodiments, during receiving of the second streaming text, if no next character is received within preset duration since a first time point when a character is received for the last time, the first time point may be used as the target time point. The preset duration is maximum duration allowed under normal circumstances when the audio conversion device waits for a next character. If the duration during which the audio conversion device waits for the next character exceeds the maximum duration, it indicates that the duration during which the audio conversion device waits for the next character exceeds an allowed normal duration range. This case may cause the audio conversion device to wait for character accumulation for a long time, and then cause a playing delay of the audio of the second streaming text. Therefore, the first time point may be used as the target time point.

In some embodiments, during receiving of the second streaming text, a number of received characters may be counted, and a second time point when the number of the characters reaches a specified number may be used as the target time point. The specified number is a maximum number of characters that can be accumulated by the audio conversion device under normal circumstances. If the number of characters accumulated by the audio conversion device exceeds the maximum number of characters, it indicates that a number of characters accumulated through audio conversion exceeds an allowed normal range. This case may cause the audio conversion device to only receive the second streaming text for a long time, but perform no audio conversion of the second streaming text, and then this causes a playing delay of the audio of the second streaming text. Therefore, the second time point may be used as the target time point.

Step S23: Obtain audio duration of the first audio after the target time point as unplayed duration of the first audio.

For ease of understanding, referring to FIG. 3, assuming that a time point D is the target time point, the audio duration of the first audio after the target time point is a time period DF.

Step S24: Convert, starting from the target time point, the second streaming text into second audio within a duration range defined by the unplayed duration and playing interval duration, where the playing interval duration represents a maximum time interval between an end time point of the first audio and a start time point of the second audio.

Specifically, the playing interval duration may be set according to an actual situation. If the first audio and the second audio need to be played continuously (that is, a playing delay of the second audio is small), the playing interval duration may be set to a smaller value. If the second audio is allowed to be delayed, the playing interval duration may be set to a larger value. In FIG. 3, a time period FH is used to represent the playing interval duration. The playing interval duration is after the unplayed duration of the first audio.

With reference to FIG. 3, it can be understood that if the second audio continues to be played within the playing interval duration after playing of the first audio is completed, it is necessary to complete audio conversion of the second streaming text within the duration range defined by the unplayed duration and the playing interval duration.

Specifically, converting the second streaming text into the second audio within the duration range defined by the unplayed duration and the playing interval duration may include the following two cases:

The first case is that the received second streaming text has been accumulated a lot within the duration range defined by the unplayed duration and the playing interval duration. In this case, the second streaming text may be segmented based on first segmentation logic, and a sentence obtained through segmentation may be converted into the second audio. A single sentence segmented based on the first segmentation logic may be longer.

The other case is that the received second streaming text is accumulated less within the duration range defined by the unplayed duration and the playing interval duration. In this case, the second streaming text may be segmented based on second segmentation logic, and a sentence obtained through segmentation may be converted into the second audio. A single sentence segmented based on the second segmentation logic may be shorter. For example, one phrase may be used as one sentence.

Under normal circumstances, during segmenting of the second streaming text, it is preferred to determine whether the accumulated second streaming text can be segmented based on the first segmentation logic, and if so, the second streaming text is segmented based on the first segmentation logic, or if not, the second streaming text is segmented based on the second segmentation logic.

FIG. 4 is a schematic sequence diagram of an audio generation method according to another embodiment of the present application. In FIG. 4, it is assumed that a time point D is a target time point, and a time point G is within unplayed duration of first audio. If at the time point G, second streaming text accumulated by an audio conversion device can be segmented based on first segmentation logic, the second streaming text can be segmented at the time point G, and a sentence obtained through segmentation can be converted into second audio. In this case, during playing of the first audio, the audio conversion device can return the second audio. After playing of the first audio is completed, the second audio can continue to be played.

Referring to FIG. 3, it is also assumed that the time point D is the target time point. A time point H is the last time point within a duration range defined by unplayed duration DF of the first audio and playing interval duration FH. If at the time point H, the second streaming text accumulated by the audio conversion device cannot be segmented based on the first segmentation logic, the second streaming text can be segmented at the time point H based on second segmentation logic, and a sentence obtained through segmentation can be converted into second audio. In this case, a playing delay of the second audio occurs, and there is a maximum time interval between an end time point of the first audio and start time point of the second audio.

To sum up, in technical solutions of some embodiments of the present application, after received first streaming text is converted into first audio, during receiving of second streaming text, unplayed duration of the first audio after a target time point is obtained, and the second streaming text is converted into second audio within a duration range defined by the unplayed duration and playing interval duration. In this way, after playing of the first audio is completed, the second audio can continue to be played without exceeding the playing interval duration at the latest, thereby effectively solving the problem of audio playing delay.

In addition, according to the present application, the duration range of audio conversion of the second streaming text is determined based on the unplayed duration of the first audio, so that when the unplayed duration of the first audio is longer, the duration range of audio conversion of the second streaming text is also correspondingly longer. This is beneficial to accumulating more second streaming text, so as to facilitate obtaining of a longer sentence through segmentation based on the first segmentation logic. However, when the unplayed duration of the first audio is shorter, the duration range of audio conversion of the second streaming text is also correspondingly shorter. This is beneficial to timely audio conversion of the second streaming text and avoiding a large delay of the second audio.

The solutions of the present application are further described below.

In some embodiments, the converting, starting from the target time point, the second streaming text into second audio within a duration range defined by the unplayed duration and playing interval duration may specifically include:
determining, by using the second streaming text received before the target time point as the text to be converted, conversion duration required for performing audio conversion on text to be converted;
using a sum of the unplayed duration and the playing interval duration as total duration; using a difference between the total duration and the conversion duration as maximum waiting duration; and
converting, starting from the target time point, the text to be converted into the second audio within the maximum waiting duration.

In these embodiments, the audio conversion of the text to be converted is completed within the obtained maximum waiting duration obtained after the conversion duration of audio conversion of the text to be converted is subtracted from the duration range defined by the unplayed duration and the playing interval duration (that is, from the total duration). In this way, time can be reserved for the audio conversion of the text, and it is ensured that the end time point of the first audio and the start time point of the second audio are within the maximum time interval after the audio conversion is completed.

For ease of understanding, taking FIG. 3 as an example, a time period EH may denote the conversion duration of the text to be converted. The above determining of the maximum waiting duration may specifically include the following:
unplayed duration DF of the first audio+maximum time interval FH=total duration DH,
total duration DH−conversion duration EF=initial waiting duration DE, and
when the initial waiting duration DE is used as the maximum waiting duration, a latest time point for audio conversion of the text to be converted cannot exceed a time point E.

Further, in this embodiment, to ensure that the determined maximum waiting duration is within a proper duration range, after the maximum waiting duration is obtained, the audio generation method according to the present application may further include:
comparing the maximum waiting duration with preset maximum duration, and if the maximum waiting duration is greater than the maximum duration, using the maximum duration as the maximum waiting duration; and/or
comparing the maximum waiting duration with preset minimum duration, and if the maximum waiting duration is less than the minimum duration, using the minimum duration as the maximum waiting duration.

Specifically, the maximum duration may represent a maximum allowable value of the maximum waiting duration, and the minimum duration may represent a minimum allowable value of the maximum waiting duration. If the maximum waiting duration is not within a range defined by the maximum duration and the minimum duration, the maximum duration or the minimum duration may be used as the maximum waiting duration. In this way, properness of the maximum waiting duration can be ensured, and control accuracy during audio conversion of the second streaming text can be improved.

The following explains how to determine the unplayed duration of the first audio.

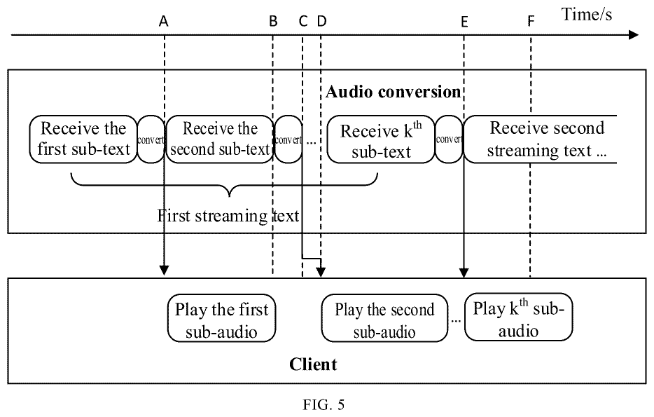

FIG. 5 is a schematic sequence diagram of an audio generation method according to another embodiment of the present application. In FIG. 5, first streaming text includes k pieces of sub-text. k is an integer greater than or equal to 1. An audio conversion device may sequentially convert each piece of sub-text into sub-audio. That is, the first audio includes k pieces of sub-audio. There may be lag duration between two adjacent pieces of sub-audio, or two adjacent pieces of sub-audio may be continuous. When there is lag duration between two adjacent pieces of sub-audio, the lag duration may include playing interval duration and a delay caused by network transmission. For example, in FIG. 5, between the first sub-audio and the second sub-audio, a time period BC may denote playing interval duration, and a time period CD may denote a delay caused by network transmission.

Based on FIG. 5, in some embodiments, the unplayed duration of the first audio may be determined based on the following method:

11) Obtain playing duration of the first audio based on total audio duration of the k pieces of sub-audio and total lag duration between the k pieces of sub-audio.

Specifically, the total audio duration may be a sum of audio duration of the k pieces of sub-audio, and the total lag duration may be a sum of lag duration between the k pieces of sub-audio. This process may be shown in expression (1):

$$total\_time = accumulate\_audio [ k ] + accumulate\_waiting [ k ] \qquad ( 1 )$$

where total_time denotes the playing duration of the first audio, accumulate_audio [k] denotes the total audio duration of the k pieces of sub-audio, and accumulate_waiting[k] denotes the total lag duration between the k pieces of sub-audio.

12) Use, as played duration of the first audio, a difference between a first time point when a character is received for the last time and a third time point when the first sub-audio is obtained through conversion.

This process may be shown in expression (2):

$$past\_time = last\_recv \_time - package\_time [ 1 ] \qquad ( 2 )$$

where past_time denotes the played duration of the first audio, last_recv_time denotes the first time point when a character is received for the last time, and package_time[1] denotes the third time point when the first sub-audio is obtained through conversion.

13) Use a difference between the playing duration and the played duration of the first audio as the unplayed duration of the first audio.

In this way, the unplayed duration of the first audio can be obtained. In the above method for obtaining the unplayed duration, the audio duration, the first time point, the third time point, and the like can be directly obtained at the audio conversion device side, which facilitates calculation.

The following describes a method for determining the total lag duration accumulate_waiting[k] between the above k pieces of sub-audio.

Referring to FIG. 5, because there is no other sub-audio before the first sub-audio and there is no other sub-audio after the k^{th} sub-audio, the total lag duration accumulate_waiting[k] between sub-audio should actually be a sum of lag duration between an n^{th} sub-audio and an (n−1)^{th} sub-audio, where a value of n ranges from 2 to k. In view of this, in some embodiments, the total lag duration accumulate_waiting[k] between the above k pieces of sub-audio may be determined based on the following method:

21): Use, as playing duration of the first n−1 pieces of sub-audio, a difference between a time point when the n^{th} sub-audio is obtained through conversion and the time point when the first sub-audio is obtained through conversion.

This process may be shown in expression (3):

$$total\_time [ n - 1 ] = package\_time [ n ] - package\_time [ 1 ] \qquad ( 3 )$$

where total_time[n−1] denotes the playing duration of the first n−1 pieces of sub-audio, package_time[n] denotes the time point when the n^{th} sub-audio is obtained through conversion, and package_time[l] denotes the time point when the first sub-audio is obtained through conversion.

22) Use a difference between the playing duration of the first n−1 pieces of sub-audio and total audio duration of the first n−1 pieces of sub-audio as lag duration between the n^{th} sub-audio and the (n−1)^{th} sub-audio.

This process may be shown in expression (4):

$$waiting [ n ] = total\_time [ n - 1 ] - accumulate\_audio [ n - 1 ] \qquad ( 4 )$$

where waiting[n] denotes the lag duration between the n^{th} sub-audio and the (n−1)^{th} sub-audio, and accumulate_audio [n−1] denotes the total audio duration of the first n−1 pieces of sub-audio.

Further, the total audio duration accumulate_audio [n−1] of the first n−1 pieces of sub-audio may be shown in expression (5):

$$accumulate\_audio [ n - 1 ] = audio [ 1 ] + audio [ 2 ] + … + audio [ n - 1 ] \qquad ( 5 )$$

where audio[1], audio[2], . . . , and audio[n−1] each denote audio duration of a respective piece of sub-audio.

Further, the difference (that is, total_time[n−1]−accumulate_audio [n−1]) between the playing duration of the first n−1 pieces of sub-audio and the total audio duration of the first n−1 pieces of sub-audio may be negative. However, in practice, the minimum lag duration between the n^{th} sub-audio and the (n−1)^{th} sub-audio can only be 0 (that is, there is no lag duration between the n^{th} sub-audio and the (n−1)^{th} sub-audio, and the audio can be played continuously). In view of this, the above using a difference between the playing duration of the first n−1 pieces of sub-audio and total audio duration of the first n−1 pieces of sub-audio as lag duration between the n^{th} sub-audio and (n−1)^{th} sub-audio may include:
using, if the difference between the playing duration of the first n−1 pieces of sub-audio and the total audio duration of the first n−1 pieces of sub-audio is greater than or equal to 0, the difference as the lag duration between the k^{th} sub-audio and the (k−1)^{th} sub-audio; or
setting, if the difference between the playing duration of the first n−1 pieces of sub-audio and the total audio duration of the first n−1 pieces of sub-audio is less than 0, the lag duration between the n^{th} sub-audio and the (n−1)^{th} sub-audio to 0.

In this way, the difference between the playing duration of the first n−1 pieces of sub-audio and the total audio duration of the first n−1 pieces of sub-audio is prevented from being negative.

23) Obtain the total lag duration accumulate_waiting[k] between the above k pieces of sub-audio based on the lag duration between the n^{th} sub-audio and (n−1)^{th} sub-audio.

In this embodiment, accumulate_waiting[k] may be as shown in expression (6):

$$accumulate\_waiting [ k ] = accumulate\_waiting [ n - 1 ] + waiting [ n ] \qquad ( 6 )$$

where accumulate_waiting[n−1] denotes the total lag duration between the first n−1 pieces of sub-audio, and waiting [n] denotes the lag duration between the n^{th} sub-audio and the (n−1)^{th} sub-audio.

So far, the related description of the audio generation method according to the present application is completed.

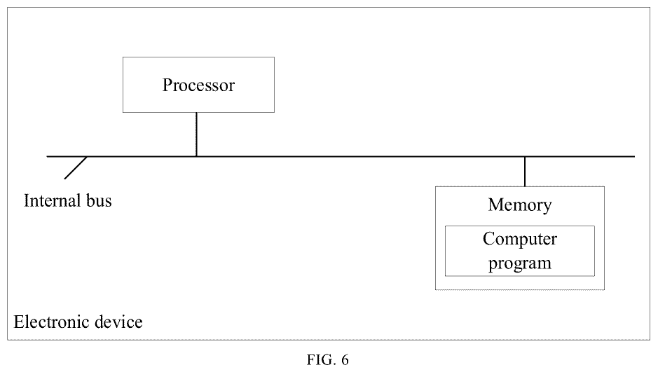

FIG. 6 is a schematic diagram of an electronic device according to an embodiment of the present application. The electronic device includes a processor and a memory. The memory is configured to store a computer program, and when the computer program is executed by the processor, the method described above is implemented.

The processor may be a central processing unit (CPU). The processor may alternatively be another general-purpose processor, a digital signal processor (DSP), an application specific integrated circuit (ASIC), a field programmable gate array (FPGA) or another programmable logic device, a discrete gate or transistor logic device, a discrete hardware component, or other chips, or a combination of the above chips.

As a non-transient computer-readable storage medium, the memory may be configured to store a non-transient software program, a non-transient computer-executable program, and modules, such as program instructions/modules corresponding to the method according to each of the implementations of the present invention. The processor executes various functional applications and data processing of the processor by running the non-transient software program, instructions, and modules stored in the memory, to implement the method according to each of the above method implementations.

The memory may include a program storage area and a data storage area. The program storage area may store an operating system and an application required by at least one function. The data storage area may store data created by the processor and the like. In addition, the memory may include a high-speed random access memory, and may further include a non-transient memory, for example, at least one disk storage device, a flash memory device, or another non-transient solid-state storage device. In some implementations, the memory optionally includes memories remotely arranged relative to the processor, and these remote memories may be connected to the processor via a network. Instances of the above network include, but are not limited to, Internet, intranet, a local area network, a mobile communication network, and a combination thereof.

An implementation of the present application further provides a non-transitory computer-readable storage medium. The computer-readable storage medium is configured to store a computer program, and when the computer program is executed by a processor, the method described above is implemented.

Although the implementations of the present disclosure are described with reference to the accompanying drawings, those skilled in the art may make various modifications and variations without departing from the spirit and scope of the present disclosure, and such modifications and variations shall all fall within the scope defined by the appended claims.

I/We claim:

1. An audio generation method, comprising:
receiving first streaming text, and converting the first streaming text into first audio;
receiving second streaming text located after the first streaming text, and determining a target time point during receiving of the second streaming text based on a number of characters of the received second streaming text or interval duration between receiving of adjacent characters;
obtaining audio duration of the first audio after the target time point as unplayed duration of the first audio; and
converting, starting from the target time point, the second streaming text into second audio within a duration range defined by the unplayed duration and playing interval duration, wherein the playing interval duration represents a maximum time interval between an end time point of the first audio and a start time point of the second audio.

2. The method according to claim 1, wherein the determining a target time point based on interval duration between receiving of adjacent characters comprises:
during receiving of the second streaming text, if no next character is received within preset duration since a first time point when a character is received for the last time, using the first time point as the target time point.

3. The method according to claim 1, wherein the determining a target time point based on a number of characters of the received second streaming text comprises:
during receiving of the second streaming text, counting a number of received characters, and using, as the target time point, a second time point when the number of characters reaches a specified number.

4. The method according to claim 1, wherein the converting, starting from the target time point, the second streaming text into second audio within a duration range defined by the unplayed duration and playing interval duration comprises:
determining, by using the second streaming text received before the target time point as text to be converted, conversion duration required for performing audio conversion on the text to be converted;
using a sum of the unplayed duration and the playing interval duration as total duration;
using a difference between the total duration and the conversion duration as maximum waiting duration; and
converting, starting from the target time point, the text to be converted into the second audio within the maximum waiting duration.

5. The method according to claim 4, wherein after the maximum waiting duration is obtained, the method further comprises:
comparing the maximum waiting duration with preset maximum duration, and if the maximum waiting duration is greater than the maximum duration, using the maximum duration as the maximum waiting duration; and/or
comparing the maximum waiting duration with preset minimum duration, and if the maximum waiting duration is less than the minimum duration, using the minimum duration as the maximum waiting duration.

6. The method according to claim 4, wherein the first audio comprises k pieces of sub-audio; and the unplayed duration is determined based on the following method of:
obtaining playing duration of the first audio based on total audio duration of the k pieces of sub-audio and total lag duration between the k pieces of sub-audio;
using, as played duration of the first audio, a difference between a first time point when a character is received for the last time and a third time point when the first sub-audio is obtained through conversion; and
using a difference between the playing duration and the played duration of the first audio as the unplayed duration of the first audio,
wherein a value of k is an integer greater than or equal to 1.

7. The method according to claim 6, wherein the total lag duration between the k pieces of sub-audio is determined based on the following method of:
using, as playing duration of the first n−1 pieces of sub-audio, a difference between a time point when n^{th} sub-audio is obtained through conversion and the time point when the first sub-audio is obtained through conversion;
using a difference between the playing duration of the first n−1 pieces of sub-audio and total audio duration of the first n−1 pieces of sub-audio as lag duration between k^{th} sub-audio and (k−1)^{th} sub-audio; and
obtaining the total lag duration between the k pieces of sub-audio based on the lag duration between the n^{th} sub-audio and (n−1)^{th} sub-audio,
wherein a value of n ranges from 2 to k.

8. The method according to claim 7, wherein the using a difference between the playing duration of the first n−1 pieces of sub-audio and total audio duration of the first n−1 pieces of sub-audio as lag duration between the n^{th} sub-audio and (n−1)^{th} sub-audio comprises:
using, if the difference between the playing duration of the first n−1 pieces of sub-audio and the total audio duration of the first n−1 pieces of sub-audio is greater than or equal to 0, the difference as the lag duration between the k^{th} sub-audio and the (k−1)^{th} sub-audio; or
setting, if the difference between the playing duration of the first n−1 pieces of sub-audio and the total audio duration of the first n−1 pieces of sub-audio is less than 0, the lag duration between the n^{th} sub-audio and the (n−1)^{th} sub-audio to 0.

9. An electronic device, comprising:
a memory and processor;
wherein the memory is configured to store one or more computer instructions which, when executed by the processor, cause the processor to:
receive first streaming text, and convert the first streaming text into first audio;
receive second streaming text located after the first streaming text, and determine a target time point during receiving of the second streaming text based on a number of characters of the received second streaming text or interval duration between adjacent characters;
obtain unplayed duration of the first audio after the target time point; and
convert, starting from the target time point, the second streaming text into second audio within a duration range defined by the unplayed duration and playing interval duration, wherein the playing interval duration represents a maximum time interval between an end time point of the first audio and a start time point of the second audio.

10. The device according to claim 9, wherein the instructions causing the processor to determine a target time point based on interval duration between receiving of adjacent characters comprise instructions causing the processor to:
during receiving of the second streaming text, if no next character is received within preset duration since a first time point when a character is received for the last time, use the first time point as the target time point.

11. The device according to claim 9, wherein the instructions causing the processor to determine a target time point based on a number of characters of the received second streaming text comprise instructions causing the processor to:
during receiving of the second streaming text, count a number of received characters, and use, as the target time point, a second time point when the number of characters reaches a specified number.

12. The device according to claim 10, wherein the instructions causing the processor to convert, starting from the target time point, the second streaming text into second audio within a duration range defined by the unplayed duration and playing interval duration comprise instructions causing the processor to:
determine, by using the second streaming text received before the target time point as text to be converted, conversion duration required for performing audio conversion on the text to be converted;
use a sum of the unplayed duration and the playing interval duration as total duration;
use a difference between the total duration and the conversion duration as maximum waiting duration; and
convert, starting from the target time point, the text to be converted into the second audio within the maximum waiting duration.

13. The device according to claim 12, wherein after the maximum waiting duration is obtained, the instructions further causes the processor to:
compare the maximum waiting duration with preset maximum duration, and if the maximum waiting duration is greater than the maximum duration, use the maximum duration as the maximum waiting duration; and/or
compare the maximum waiting duration with preset minimum duration, and if the maximum waiting duration is less than the minimum duration, use the minimum duration as the maximum waiting duration.

14. The device according to claim 12, wherein the first audio comprises k pieces of sub-audio; and the instructions causing the processor to determine the unplayed duration based on the following method comprise instructions causing the processor to:
obtain playing duration of the first audio based on total audio duration of the k pieces of sub-audio and total lag duration between the k pieces of sub-audio;
use, as played duration of the first audio, a difference between a first time point when a character is received for the last time and a third time point when the first sub-audio is obtained through conversion; and
use a difference between the playing duration and the played duration of the first audio as the unplayed duration of the first audio,
wherein a value of k is an integer greater than or equal to 1.

15. The device according to claim 14, wherein the instructions causing the processor to determine the total lag duration between the k pieces of sub-audio based on the following method comprise instructions causing the processor to:
use, as playing duration of the first n−1 pieces of sub-audio, a difference between a time point when n^{th} sub-audio is obtained through conversion and the time point when the first sub-audio is obtained through conversion;
use a difference between the playing duration of the first n−1 pieces of sub-audio and total audio duration of the first n−1 pieces of sub-audio as lag duration between k^{th} sub-audio and (k−1)^{th} sub-audio; and
obtain the total lag duration between the k pieces of sub-audio based on the lag duration between the n^{th} sub-audio and (n−1)^{th} sub-audio,
wherein a value of n ranges from 2 to k.

16. The device according to claim 15, wherein the instructions causing the processor to use a difference between the playing duration of the first n−1 pieces of sub-audio and total audio duration of the first n−1 pieces of sub-audio as lag duration between the n^{th} sub-audio and (n−1)^{th} sub-audio comprise instructions causing the processor to:
use, if the difference between the playing duration of the first n−1 pieces of sub-audio and the total audio duration of the first n−1 pieces of sub-audio is greater than or equal to 0, the difference as the lag duration between the k^{th} sub-audio and the (k−1)^{th} sub-audio; or
set, if the difference between the playing duration of the first n−1 pieces of sub-audio and the total audio duration of the first n−1 pieces of sub-audio is less than 0, the lag duration between the n^{th} sub-audio and the (n−1)^{th} sub-audio to 0.

17. A non-transitory computer-readable storage medium comprising instructions stored thereon which, when executed by a processor, cause the processor to:
receive first streaming text, and converting the first streaming text into first audio;
receive second streaming text located after the first streaming text, and determining a target time point during receiving of the second streaming text based on a number of characters of the received second streaming text or interval duration between receiving of adjacent characters;
obtain audio duration of the first audio after the target time point as unplayed duration of the first audio; and
convert, starting from the target time point, the second streaming text into second audio within a duration range defined by the unplayed duration and playing interval duration, wherein the playing interval duration represents a maximum time interval between an end time point of the first audio and a start time point of the second audio.

18. The medium according to claim 17, wherein the instructions causing the processor to determine a target time point based on interval duration between receiving of adjacent characters comprise instructions causing the processor to:
during receiving of the second streaming text, if no next character is received within preset duration since a first time point when a character is received for the last time, use the first time point as the target time point.

19. The medium according to claim 18, wherein the instructions causing the processor to determine a target time point based on a number of characters of the received second streaming text comprise instructions causing the processor to:
during receiving of the second streaming text, count a number of received characters, and use, as the target time point, a second time point when the number of characters reaches a specified number.

20. The medium according to claim 19, wherein the instructions causing the processor to convert, starting from the target time point, the second streaming text into second audio within a duration range defined by the unplayed duration and playing interval duration comprise instructions causing the processor to:
determine, by using the second streaming text received before the target time point as text to be converted, conversion duration required for performing audio conversion on the text to be converted;
use a sum of the unplayed duration and the playing interval duration as total duration;
use a difference between the total duration and the conversion duration as maximum waiting duration; and
convert, starting from the target time point, the text to be converted into the second audio within the maximum waiting duration.
